(19) United States
(12) Patent Application Publication
(10) Pub. No.: US 2008/0226932 A1
(43) Pub. Date: Sep. 18, 2008

(54) Use of Modified Wood Materials for Producing Articles

(75) Inventors: Arend Jouke Kingma, Ludwigshafen (DE); Franz Weingart, Weinheim (DE); Stefan Schaffert, Bensheim (DE); Oliver Juttner, Sinzheim (DE); Holger Militz, Bovenden (DE); Andreas Krause, Bovenden (DE); Falko Wepner, Aspen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/067,876

(22) PCT Filed: Sep. 22, 2006
(86) PCT No.: PCT/EP2006/066624

§ 371 Date: Apr. 22, 2008

(30) Foreign Application Priority Data
Sep. 23, 2005 (DE) 102005045533.6

(51) Int. Cl. B27K 3/15

(52) U.S. Cl. 428/541

(57) ABSTRACT

The present invention relates to the use of modified wood materials for producing articles which comprise at least one wood material.

The present invention relates to the use of modified wood materials for the production of articles which comprise at least one wood material.

The natural durability of wood is influenced by the behavior of the wood with changes in humidity. The swelling and shrinkage of the wood which are associated with the ability of the wood to absorb water and release it again leads to problems in the production of articles which are produced partly or completely from wood materials, in particular if two or more parts are connected to one another by a friction joint or interlocking joint, since the strength of such joints between wood parts is of course reduced to a particular degree by the swelling/shrinkage behavior of the wood. In an extreme case, the swelling/shrinkage behavior leads to destruction of the friction joint.

The dimensional change also frequently leads to destruction of the wood surface of the material and coatings supplied thereon, so that the wood is subjected to biological decomposition processes to a greater extent.

For improving the durability and, wood and comparable lignocellulose-based materials are frequently rendered hydrophobic, for example by treatment with wax-containing impregnating agents. As a result of this, penetration of water into the pores of the material is hampered.

It was proposed to improve the dimensional stability of wood and wood materials, such as particleboards and fiberboards and their resistance to wood-destroying organisms by acetylation of the wood particles with the aid of anhydrides, such as acetic anhydride (cf. EP-A 213252 and literature cited therein and Rowell et al., Wood and Fiber Science, 21(1), pages 67-79). The high costs of the treatment and the unpleasant intrinsic odor of the material thus treated are disadvantageous, so that these measures have not become established on the market.

From the publication “Treatment of timber with water soluble dimethylol resins to improve the dimensional stability and durability”, which appeared in Wood Science and Technology 1993, pages 347-355, it is known that the shrinkage and swelling properties of wood and the resistance to fungi and insects can be improved by treating it with an impregnating agent which consists of an aqueous solution of dimethyloldihydroxyethyleneurea (DMDHEU or 1,3-bis(hydroxymethyl)-4,5-dihydroxy-imidazolidin-2-one) and a catalyst. At elevated temperature, the reaction of the DMDHEU with itself and with the wood takes place. In this way, wood bodies having dimensions of 20 mm×20 mm×10 mm were investigated. The process described can be used only in the case of small dimensions of the wood bodies because they tend to crack in the case of greater dimensions.

WO 2004/033170 describes a process for improving the surface hardness of wood, in which an untreated wood body is impregnated with an aqueous solution of a crosslinkable nitrogen compound from the group consisting of 1,3-bis(hydroxymethyl)-4,5-dihydroxyimidazolidin-2-one, 1,3-bis(hydroxymethyl)-4,5-dihydroxyimidazolidin-2-one modified with a C₁₋₅-alcohol, a polyol or mixtures thereof, 1,3-dimethyl-4,5-dihydroxyimidazolidin-2-one, dimethylolurea, bis(methoxymethyl)urea, tetramethylolacetylenediurea, 1,3-bis(hydroxymethyl)imidazolidin-2-one and methylolmethylurea, which solution comprises a catalyst which effects crosslinking of these compounds, and said wood body is then hardened at elevated temperature while maintaining humid conditions. WO 2004/033171 discloses a similar process in which the impregnating solution comprises a bis(hydroxymethyl)-4,5-dihydroxy-imidazolidinone modified with alkanols or polyols, 1,3-bis(hydroxymethyl)urea, 1,3-bis(methoxymethyl)urea, 1-hydroxymethyl-3-methylurea, 1,3-bis(hydroxymethyl)-imidazolidin-2-one, 1,3-dimethyl-4,5-dihydroxyimidazolidin-2-one or tetra(hydroxy-methyl)acetylenediurea.

PCT/EP2006/004020 (prior German Patent Application 102005020387.6) describes the surface treatment of moldings of modified wood or modified wood materials or other materials comprising modified lignocellulose materials, the modified wood material or the modified material comprising the lignocellulose material being impregnated beforehand with crosslinkable nitrogen compounds and crosslinked beforehand, similarly to in WO 2004/033170 and WO 2004/033171.

PCT/EP2006/004019 (prior German Patent Application 102005020386.8) discloses modified wood materials which are impregnated with a reactive composition based on crosslinkable nitrogen compounds and crosslinked, which composition comprises at least one effect substance in dissolved or dispersed form in addition to at least one crosslinkable nitrogen compound.

PCT/EP2006/004016 and PCT/EP2006/004014 (prior German Patent Applications 102005020390.6 and 102005020389.2) disclose modified wood materials which are impregnated with a reactive composition and crosslinked, which composition comprises a dispersed, hydrophobic constituent in addition to at least one crosslinkable nitrogen compound.

The prior German Patent Application PCT/EP2006/001979 (DE 102005010042.2) discloses modified wood materials comprising finely divided wood materials, in which the finely divided wood material is impregnated with a reactive composition based on crosslinkable nitrogen compounds and subjected to a shaping process in which crosslinking is carried out simultaneously. The crosslinking can also be effected before the shaping process.

The prior German Patent Application PCT/EP2006/001980 (DE 1020050100041.4) discloses modified wood materials which have at least one thin veneer layer adhesively bonded extensively to a substrate or further veneer layers, the veneer layer being impregnated with a reactive composition based on crosslinkable nitrogen compounds, coated with glue and adhesively bonded to give a veneer.

The prior German Patent Application PCT/EP2006/001980 (DE 102005020388.4) discloses modified wood materials which are impregnated with a reactive composition and are crosslinked, which composition comprises
a) at least one low molecular weight compound V which has at least two N-bonded groups of the formula CH₂OH and/or a 1,2-bishydroxyethane-1,2-diyl group bridging two nitrogen atoms, and
b) at least one oligo- or polyalkylene ether polyol P having on average at least 2 OH groups, in particular from 2 to 6 OH groups, per molecule, which has at least one divalent or polyvalent aliphatic or cycloaliphatic group having at least 3 carbon atoms, in particular having 3 to 10 carbon atoms, and/or
c) a reaction product of a low molecular weight compound V with a polyalkylene ether polyol.

It is the object of the present invention to provide novel uses for such modified wood materials.

It was surprisingly found that the modified wood materials known from the prior art are particularly suitable for the production of articles which comprise at least one wood material.

Accordingly, the present invention relates to the use of modified wood materials (wood-base materials) which comprise at least one crosslinkable nitrogen compound in a crosslinked form distributed in the wood, for the production of articles which comprise at least one wood material.

The use of wood materials modified in this manner allows the production of articles having improved mechanical strength and improved stability to weathering, in particular reduced cracking in those regions which are produced from the wood material and reduced susceptibility of these regions to infestation with wood-damaging organisms, such as wood-destroying fungi.

In particular, the modified wood materials are suitable for the production of articles which are produced from a plurality of parts connected to one another, at least one part being produced from a modified wood material since, owing to the reduced swelling/shrinkage behavior of the modified wood, the connections between the various parts are more stable and are subject to less mechanical damage under the influences of weathering and can better maintain their function. This is true particularly when the parts produced from the modified wood material are connected to one another or to parts comprising other materials at least partly by friction joints and/or interlocking joints, especially by a friction joint or interlocking joint with a friction component.

According to the invention, all modified wood materials which are known from the prior art and comprise at least one crosslinkable nitrogen compound in a crosslinked form distributed in the wood are in principle suitable.

In the context of the present invention, a modified wood material is understood as meaning wood, i.e. solid wood, and a wood-base material including a veneer material and a wood-base material produced from finely divided wood particles, wherein the wood constituent comprises at least one crosslinkable nitrogen compound in a crosslinked form distributed in the wood. The finely divided wood particles include fibers, splinters, strands, chips, shreds and the like. In the context of the invention, a veneer material is a wood-base material which has at least one veneer layer. Veneer is understood as meaning thin sheet-like wood materials having thicknesses of <5 mm, in particular <2 mm.

In particular, the wood material is solid wood, i.e. having a large size with dimensions in the centimeter or meter range, e.g. boards, logs, round timber, beams or the like.

Crosslinked means that the proportion of extractable constituents of the nitrogen compound is not more than 50% by weight, based on the total amount of the nitrogen compound present in the wood. The extractable fraction is determined via the nitrogen content of a modified wood material before and after extraction with hot water. For this purpose, a modified wood material is milled to a wood meal and dried until absolutely dry and the nitrogen content of the wood is determined by means of elemental analysis. Thereafter, a sample of the wood meal is extracted with water at 80° C. for 16 h, filtered off and dried again until absolutely dry and the nitrogen content of the sample thus obtained is determined by means of elemental analysis. Since unmodified wood itself comprises no detectable amounts of nitrogen, the extractable fraction in %, based on the nitrogen value of the sample before extraction, is obtained directly from the difference between the nitrogen contents before and after the extraction. Distributed in the wood means that the crosslinked nitrogen compound is distributed more or less uniformly over the cross section of the wood and is not present only on the surface or in cavities of the wood.

The amount of crosslinked nitrogen compound in the wood is as a rule at least 0.5% by weight, in particular at least 1% by weight, frequently at least 2% by weight and typically in the range from 1 to 20% by weight, frequently in the range from 2 to 15% by weight, calculated as nitrogen and based on the weight of the wood material (wood-base material). The nitrogen content can be determined by means of elemental analysis.

Suitable crosslinkable nitrogen compounds for modifying the wood are
α) low molecular weight compounds V which have at least two N-bonded groups of the formula CH₂OR, where R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol which is selected from C₁-C₆-alkanols, C₂-C₆-polyols and oligoalkylene glycols.

The crosslinkable nitrogen compounds used for modifying the wood material, i.e. compounds V, and the precondensates and reaction products thereof are low molecular weight compounds or oligomers having a low molecular weight, which as a rule are present in completely dissolved form in the aqueous composition used. The molecular weight of the crosslinkable compound is usually below 400 Dalton. It is assumed that, owing to these properties, the crosslinkable nitrogen compounds can penetrate into the cell walls of the wood and, on hardening, improve the mechanical stability of the cell walls and reduce the swelling thereof caused by water.

Examples of crosslinkable nitrogen compounds are the following, without being limited thereto:
1,3-bis(hydroxymethyl)-4,5-dihydroxyimidazolidin-2-one (DMDHEU),
1,3-bis(hydroxymethyl)-4,5-dihydroxyimidazolidin-2-one which is modified with a C₁-C₆-alkanol, a C₂-C₆-polyol or an oligoalkylene glycol (modified DMDHEU or mDMDHEU),
1,3-bis(hydroxymethyl)urea,
1,3-bis(methoxymethyl)urea;
1,3-bis(hydroxymethyl)imidazolidin-2-one (dimethylolethyleneurea),
1,3-bis(hydroxymethyl)-1,3-hexahydropyrimidin-2-one (dimethylolpropyleneurea),
1,3-bis(methoxymethyl)-4,5-dihydroxyimidazolidin-2-one (DMeDHEU),
tetra(hydroxymethyl)acetylenediurea,
low molecular weight melamine-formaldehyde resins (MF resins) such as poly(hydroxymethyl)melamine having at least 2, e.g. 2, 3, 4, 5 or 6 N-hydroxy-methyl groups, such as trimethylolated melamine (=2,4,6-tris-(N-hydroxymethylamino)-1,3,5-triazine and
low molecular weight melamine-formaldehyde resins (MF resins), such as poly(hydroxymethyl)melamine having at least 2, e.g. 2, 3, 4, 5 or 6, N-hydroxymethyl groups which are modified with a C₁-C₆-alkanol, a C₂-C₆-polyol or an oligoalkylene glycol (modified MF resins).

Aqueous compositions of compounds V, the precondensates thereof and the reaction products thereof are known per se, for example from WO 2004/033171, WO 2004/033170, K. Fisher et al. “Textile Auxiliaries—Finishing Agents” section 7.2.2 in Ullmann's Encyclopedia of Industrial Chemistry, 5th Ed. on CD-ROM, Wiley-VCH, Weinheim 1997 and literature cited there, U.S. Pat. No. 2,731,364, U.S. Pat. No. 2,930,715, H. Diem et al. “Amino-Resins” sections 7.2.1 and 7.2.2 in Ullmann's Encyclopedia of Industrial Chemistry, 5th Ed. on CD-ROM, Wiley-VCH, Weinheim 1997 and literature cited there, Houben-Weyl E20/3, pages 1811-1890, and are usually used as crosslinking agents for textile finishing. Reaction products of N-methylolated urea compounds V with alcohols, e.g. modified 1,3-bis(hydroxymethyl)-4,5-dihydroxyimidazolidin-2-one (mDMDHEU), are disclosed, for example, in U.S. Pat. No. 4,396,391 and WO 98/29393. Besides, compounds V and their reaction products and precondensates are commercially available, for example under the trade names Fixapret® CP and Fixapret® ECO of BASF Aktiengesellschaft, the Luwipal® and the Kauramin® brands (e.g. Kauramin 650 Powder) of BASF.

In a preferred embodiment of the invention, the crosslinkable nitrogen compound is selected from urea compounds which have, at each nitrogen atom, in each case an N-bonded group of the formula CH₂OR, in which R is hydrogen or C₁-C₄-alkyl, and/or a 1,2-bishydroxyethane-1,2-diyl group which bridges the two nitrogen atoms, and the reaction products of these urea compounds with a C₁-C₆-alkanol, a C₂-C₆-polyol and/or a polyalkylene glycol. These preferably include 1,3-bis(hydroxymethyl)-4,5-dihydroxyimidazolidin-2-one and a 1,3-bis(hydroxymethyl)-4,5-dihydroxyimidazolidin-2-one modified with a C₁-C₆-alkanol, a C₂-C₆-polyol and/or a polyalkylene glycol. Examples of polyalkylene glycols are in particular the oligo- and poly-C₂-C₄-alkylene glycols mentioned below.

mDMDHEU are reaction products of 1,3-bis(hydroxymethyl)-4,5-dihydroxyimidazolidin-2-one with a C₁-C₆-alkanol, a C₂-C₆-polyol, an oligoethylene glycol or mixtures of these alcohols. Suitable C₁₋₆-alkanols are, for example, methanol, ethanol, n-propanol, isopropanol, n-butanol and n-pentanol, methanol being preferred. Suitable polyols are ethylene glycol, diethylene glycol, 1,2- and 1,3-propylene glycol, 1,2-, 1,3-, and 1,4-butylene glycol and glycerol. Examples of suitable polyalkylene glycols are in particular the oligo- and poly-C₂-C₄-alkylene glycols mentioned below. For the preparation of mDMDHEU, DMDHEU are mixed with the alkanol, the polyol or the polyalkylene glycol. The monohydric alcohol, the polyol or the oligo- or polyalkylene glycol is usually used here in a ratio of from 0.1 to 2.0, in particular from 0.2 to 2 mole equivalents each, based on DMDHEU. The mixture of DMDHEU, the polyol or the polyalkylene glycol is usually reacted in water at temperatures of, preferably, from 20 to 70° C. and a pH of, preferably, from 1 to 2.5, the pH being adjusted as a rule to a range from 4 to 8 after the reaction.

In a further preferred embodiment of the invention, the crosslinkable nitrogen compound is selected from at least dimethylolated, e.g. dimethylolated, trimethylolated, tetramethylolated, pentamethylolated or hexamethylolated, in particular trimethylolated to pentamethylolated and especially trimethylolated or tetramethylolated, melamine (poly(hydroxymethyl)melamine) or a mixture thereof. Likewise suitable are partially or completely etherified derivatives of these methylolated melamines, for example those which are modified with a C₁-C₆-alkanol, especially methanol, a C₂-C₆-polyol and/or a polyalkylene glycol, and mixtures thereof with the unmodified melamine compounds. Examples of polyalkylene glycols are in particular the oligo- and poly-C₂-C₄-alkylene glycols mentioned below.

The aqueous compositions usually used for the modification can also comprise one or more of the abovementioned alcohols, C₁-C₆-alkanols, C₂-C₆-polyols, oligo- and polyalkylene glycols or mixtures of these alcohols. Suitable C₁₋₆-alkanols are, for example, methanol, ethanol, n-propanol, isopropanol, n-butanol and n-pentanol, methanol being preferred. Suitable polyols are ethylene glycol, diethylene glycol, 1,2- and 1,3-propylene glycol, 1,2-, 1,3-, and 1,4-butylene glycol and glycerol. Suitable oligo- and polyalkylene glycols are in particular oligo- and poly-C₂-C₄-alkylene glycols, especially homo- and cooligomers of ethylene oxide and/or of propylene oxide, which are obtainable, if appropriate, in the presence of low molecular weight initiators, for example aliphatic or cycloaliphatic polyols having at least 2 OH groups, such as 1,3-propanediol, 1,3- and 1,4-butanediol, 1,5-pentanediol, 1,6-hexanediol, glycerol, trimethylolethane, trimethylolpropane, erythritol and pentaerythritol, and pentitols and hexitols, such as ribitol, arabitol, xylitol, dulcitol, mannitol and sorbitol, and inositol or aliphatic or cycloaliphatic polyamines having at least 2 NH₂ groups, such as diethylenetriamine, triethylenetetramine, tetraethylenepentamine, propylene-1,3-diamine, dipropylenetriamine, 1,4,8-triaza-octane, 1,5,8,12-tetra-azadodecane, hexamethylenediamine, dihexamethylenetriamine, 1,6-bis-(3-aminopropyl-amino)hexane, N-methyldipropylenetriamine or polyethyleneimine, among which diethylene glycol, triethylene glycol, di-, tri- and tetrapropylene glycol and low molecular weight Pluronic® brands of BASF (e.g. Pluronic® PE 3100, PE 4300, PE 4400, RPE 1720, RPE 1740) are preferred.

If present, the concentration of the crosslinkable nitrogen compounds in the aqueous composition is usually in the range from 1 to 60% by weight, frequently in the range from 10 to 60% by weight and in particular in the range from 15 to 50% by weight, based on the total weight of the composition. If the aqueous composition comprises one of the abovementioned alcohols, the concentration thereof is preferably in the range from 1 to 50% by weight, in particular in the range from 5 to 40% by weight. The total amount of crosslinkable compound and alcohol usually accounts for from 10 to 60% by weight and in particular from 20 to 50% by weight of the total weight of the aqueous composition.

As a rule, the aqueous composition used for the modification comprises at least one catalyst K which produces the crosslinking of the nitrogen compound. As a rule, metal salts from the group consisting of the metal halides, metal sulfates, metal nitrates, metal phosphate and metal tetrafluoroborates; boron trifluoride; ammonium salts from the group consisting of the ammonium halides, ammoniumsulfate, ammonium oxalate and diammonium phosphate; and organic carboxylic acids, organic sulfonic acids, inorganic Brönsted acids such as boric acid, phosphoric acid, sulfuric acid and hydrochloric acid are suitable as catalysts K.

Examples of metal salts suitable as catalysts K are in particular magnesium chloride, magnesium sulfate, zinc chloride, lithium chloride, lithium bromide, aluminum chloride, aluminum sulfate, zinc nitrate and sodium tetrafluoroborate.

Examples of ammonium salts suitable as catalysts K are in particular ammonium chloride, ammonium sulfate, ammonium oxalate and diammonium phosphate.

Water-soluble organic carboxylic acids, such as maleic acid, formic acid, citric acid, tartaric acid and oxalic acid, and furthermore benzenesulfonic acids, such as p-toluenesulfonic acid, but also inorganic Brönsted acids, such as hydrochloric acid, phosphoric acid, sulfuric acid, boric acid or mixtures thereof, are particularly suitable as catalysts K.

The catalyst K is preferably selected from magnesium chloride, zinc chloride, magnesium sulfate, aluminum sulfate or mixtures thereof, magnesium chloride being particularly preferred.

The catalyst K is usually added to the aqueous composition only shortly before the modification process. It is usually used in an amount of from 1 to 20% by weight, in particular from 2 to 10% by weight, based on the total weight of the curable constituents present in the aqueous composition. The concentration of the catalyst, based on the total weight of the aqueous dispersion, is usually in the range from 0.1 to 10% by weight and in particular in the range from 0.5 to 5% by weight.

Furthermore, the composition used for modifying the wood may comprise one or more effect substances, for example a colorant, e.g. a dye or a pigment, a UV stabilizer, an antioxidant, a fungicide and/or insecticide and the like, as described in PCT/EP2006/004019 (prior German Patent Application 102005020386.8), which is hereby incorporated by reference. Depending on the effect substance, the concentration of effect substance is in the range from 0.01 to 60% by weight and in particular from 0.1 to 25% by weight, based on the weight of the composition.

Furthermore, the composition used for modifying the wood may comprise one or more hydrophobic constituents, for example a wax or an oil, in emulsified or suspended form, as described in PCT/EP2006/004014 and PCT/EP2006/004016 (prior German Patent Applications DE 102005020389.2 and DE 102005020390.6), which are hereby incorporated by reference. The concentration of hydrophobic constituent is typically in the range from 0.01 to 60% by weight and in particular from 0.1 to 25% by weight, based on the weight of the composition.

The modified wood materials and the articles produced therefrom may have a conventional coating, for example a finish, a glaze or a stain, as described in PCT/EP2006/004020 (DE 102005020387.6) which is hereby incorporated by reference.

The production of the modified wood materials can be effected by the processes described in the prior art cited at the outset, which is hereby likewise incorporated by reference.

As a rule, in the case of solid wood, the production of the modified wood material comprises:
a) impregnation of solid wood with an aqueous composition which comprises at least one crosslinkable nitrogen compound and at least one catalyst producing the crosslinking, and
b) treatment of the impregnated solid wood obtained in step a) at elevated temperature with removal of water.

As a rule, the production of a modified wood-base material comprises the steps described in PCT/EP2006/001979 (DE 102005010042.2):
a) impregnation of a finely divided wood material with an aqueous composition which comprises at least one crosslinkable nitrogen compound and at least one catalyst which produces the crosslinking, and
b) treatment of the impregnated wood material obtained in step a) at elevated temperature with removal of water,
c) application of glue and shaping of the finely divided wood material obtained in step b)
   or
b′) application of glue to the impregnated wood material obtained in step a), if appropriate after drying, and
c′) shaping of the wood material at elevated temperature with removal of water, a wood-base material being obtained.

As a rule the production of a modified veneer material comprises the steps described in PCT/EP2006/001980 (DE 102005010041.4):
a) impregnation of a veneer with an aqueous composition which comprises at least one crosslinkable nitrogen compound and at least one catalyst which produces the crosslinking, and
b) application of a glue composition to the impregnated veneer and
c) processing of the veneer to which glue has been applied to give a veneer material at elevated temperature with curing of the crosslinkable nitrogen compound.

The impregnation can be effected in a customary manner, for example by immersion, by application of reduced pressure, if appropriate in combination with pressure, or by conventional application methods, such as brushing, spraying and the like. The impregnation process used in each case does of course depend on the dimensions of the material to be impregnated. Wood materials having small dimensions, such as splinters or strands, and thin veneers, i.e. materials having a large ratio of surface to volume, can be impregnated with little effort, for example by immersion or spraying, whereas wood materials having larger dimensions, in particular materials whose smallest dimension is more than 5 mm, e.g. solid wood, shaped articles of solid wood or wood materials, are impregnated with application of pressure or reduced pressure, in particular by combined application of pressure and reduced pressure. Advantageously, the impregnation is carried out at a temperature below 50° C., e.g. in the range from 15 to 50° C.

The impregnation conditions are as a rule chosen so that the absorbed amount of curable constituents of the aqueous composition is at least 1% by weight, based on the dry mass of the untreated material. The absorbed amount of curable constituents may be up to 100% by weight, based on the dry mass of the untreated materials and is frequently in the range from 1 to 60% by weight, preferably in the range from 5 to 50% by weight and in particular in the range from 10 to 30% by weight, based on the dry mass of the untreated material used. The moisture content of the untreated materials used for the impregnation is not critical and may be, for example, up to 100%. Hereinbelow, the term “moisture content” is synonymous with the term residual moisture content according to DIN 52183. Frequently, it is the range from 1 to 80% and in particular from 5 to 50%.

For immersion, the wood material, if appropriate after predrying, is immersed into a container in which the aqueous composition is present. The immersion is preferably effected over a period of from a few seconds to 24 h, in particular from 1 min to 6 h. The temperatures are usually in the range from 15° C. to 50° C. The wood material absorbs the aqueous composition thereby, rendering it possible for the amount of these constituents which is absorbed by the wood material to be controlled by the concentration of the nonaqueous constituents (i.e. curable constituents) in the aqueous composition, by the temperature and by the duration of treatment. The amount of constituents which is actually absorbed can be determined and controlled by the person skilled in the art in a simple manner via the weight increase of the impregnated material and the concentration of the constituents in the aqueous composition.

The impregnation is advantageously effected by combined application of reduced and superatmospheric pressure. For this purpose the wood material, which as a rule has a moisture content in the range from 1% to 100%, is firstly brought into contact with the aqueous composition under reduced pressure, which is frequently in the range from 10 to 500 mbar and in particular in the range from 40 to 100 mbar, for example by immersion in the aqueous composition. The duration is usually in the range from 1 min to 5 h. This is followed by a phase at superatmospheric pressure, e.g. in the range from 2 to 20 bar, in particular from 4 to 15 bar and especially from 5 to 12 bar. The duration of this phase is usually in the range from 1 min to 12 h. The temperatures are usually in the range from 15 to 50° C. The wood material absorbs the aqueous composition thereby, making it possible for the amount of these constituents which is absorbed by the wood material to be controlled by the concentration of the nonaqueous constituents (i.e. curable constituents) in the aqueous composition, by the pressure, by the temperature and by the duration of treatment. Here too, the amount actually absorbed can be calculated via the weight increase of the wood material.

Furthermore, the impregnation can be effected by conventional processes for application of liquids to surfaces, for example by spraying or rolling or brushing. For this purpose, the material having a moisture content of not more than 50%, in particular not more than 30%, for example in the range from 12% to 30%, is advantageously used. The application is usually effected at temperatures in the range from 15 to 50° C. The spraying can be carried out in a conventional manner in all apparatuses suitable for the spraying of sheet-like or finely divided bodies, for example by means of nozzle arrangements and the like. In the case of brushing or rolling, the desired amount of aqueous composition is applied to the sheet-like materials by means of rollers or brushes.

Subsequently, in step b) the curing of the crosslinkable constituents of the aqueous composition is effected. The curing can be carried out analogously to the processes described in the prior art, for example by the processes described in WO 2004/033170 and WO 2004/033171.

The curing is typically effected by treating the impregnated material at temperatures above 80° C., in particular above 90° C., for example in the range from 90 to 220° C. and in particular in the range from 100 to 200° C. The time required for the curing is typically in the range from 10 min to 72 hours. In the case of veneers and finely divided wood materials, higher temperatures and shorter times can preferably be used.

If appropriate, a drying step, also referred to as predrying step below, can be carried out before the curing. Here, the volatile constituents of the aqueous composition, in particular the water and excess organic solvents which do not react in the curing/crosslinking of the urea compounds, are partly or completely removed. Predrying means that the wood body is dried to below the fiber saturation point, which, depending on the type of wood, is about 30% by weight. This predrying counteracts the risk of cracking. In the case of wood bodies having small dimensions, for example veneers, the predrying can be omitted. In the case of wood bodies having larger dimensions, however, the predrying is advantageous. If a separate predrying is carried out, this is advantageously effected at temperatures in the range from 20 to 80° C. Depending on the chosen drying temperature, partial or complete curing/crosslinking of the curable constituents present in the composition can be effected. The combined predrying/curing of the impregnated materials is usually effected by applying a temperature profile, which may range from 50° C. to 220° C., in particular from 80 to 200° C.

The curing/drying can be carried out in a conventional fresh air/exhaust air system, e.g. a drum dryer. The predrying is preferably effected in a manner such that the moisture content of the finely divided lignocellulose materials is not more than 30%, in particular not more than 20%, based on the dry mass, after the predrying. It may be advantageous to carry out the drying/curing to a moisture content of <10% and in particular <5%, based on the dry mass. The moisture content can be controlled in a simple manner by the temperature, the duration and the pressure chosen in the predrying.

If appropriate, adhering liquid is removed by mechanical methods before the drying/curing.

In the case of materials having large dimensions, it has proven useful to fix them during the drying/curing, for example in hot presses.

With regard to finely divided materials or veneer layers, the wood materials impregnated in step a) can be further processed in a manner known per se, in the case of finely divided materials, for example, moldings, such as OSB boards (oriented structural board), particleboards, wafer boards, OSL boards or OSL shaped articles (oriented strand lumber), PSL boards or PSL shaped articles (parallel strand lumber), boards or shaped articles of constructed strand lumber, SCL shaped articles or boards (structural composite lumber), LSL shaped articles or boards (laminated strand lumber), insulating boards and medium density (MDF) and high density (HDF) fiber boards and the like, in the case of veneers to give veneer materials, such as veneered fiber boards, veneered blackboards, veneered particleboards, including veneered OSB, SCL, OSL and PSL boards, plywood, glued laminated wood, laminated wood, veneered laminated wood (e.g. Kerto laminated wood), multiplex boards, laminated veneer lumber (LVL), but also non-sheet-like 3-dimensionally shaped components, such as shaped laminated wood articles, shaped plywood articles and any other shaped articles laminated with at least one veneer layer. The further processing can be effected immediately after the impregnation in step a) or during or after the curing in step b). In the case of veneers and wood-base materials, the further processing comprises a gluing step in addition to the curing and adhesive bonding or shaping. For details in this context, reference is made to the content of PCT/EP2006/001980 (102005010041.4 veneer materials) and the content of PCT/EP2006/001979 (102005010042.2 wood-base materials). In the case of impregnated veneers the further processing is advantageously carried out before the curing step or together with the curing step. In the case of wood-base materials comprising finely divided materials, the shaping step and curing step are frequently carried out simultaneously.

In principle all wood varieties are suitable for the production of modified wood materials, preferably those which can absorb at least 30%, in particular 50%, of their dry weight of water, and particularly preferably those which are assigned to the impregnatability classes 1 and 2 according to DIN EN 350-2. These include, for example, lumbers of conifers, such as pine (Pinus spp.), spruce, Douglas fir, larch, stone pine, fir, grand fir, cedar and Swiss pine, and lumbers of deciduous trees, e.g. maple, hard maple, acacia, ayons, birch, pear, beech, oak, alder, aspen, ash, service tree, hazel, hornbeam, cherry, chestnut, lime, American walnut, poplar, olive, locust, elm, walnut, rubber tree, zebrano, willow, Turkey oak and the like. Since properties otherwise possessed only by tropical lumbers, for example extremely low swelling/shrinkage behavior, high strengths and good stability to weathering, are achieved by the impregnation even in the case of economical lumbers, a particular embodiment of the invention relates to the use of modified wood or wood material whose wood constituent is selected from beech, spruce, pine, birch, poplar, ash and maple.

As already explained above wood materials modified according to the invention are suitable in particular for the production of articles which comprise a plurality of parts connected to one another, at least one part being produced from a modified wood material (wood-base material).

They are suitable in particular for the production of articles wherein at least two parts of the article are connected to one another by a friction joint, at least one part of the parts connected to one another by a friction joint being produced from a modified wood material (wood-base material). They are also particularly suitable for the production of articles in which at least two parts of the article are connected to one another by an interlocking joint, in particular an interlocking joint having a friction component, at least one part of the parts connected to one another by an interlocking joint being produced from a modified wood material (wood-base material).

The interlocking or friction joints can of course also be supported by bonding means, for example by gluing.

Examples of friction joints or interlocking joints having a friction component are screwed and nailed joints, pegged joints and tongue-and-groove joints, furthermore intermeshing joints, including box joints, half-lapped intermeshing, open intermeshing (dovetail joints), miter dovetailing and finger joints, triangular notch joints, housed joints, comb joints, dowel-reinforced joints and other nonbonded joints customary in wood construction.

Owing to their insensitivity to moisture influences, the invention relates in particular to the use of modified wood materials for the production of articles which are exposed to moisture or weathering conditions. The influence of moisture may be contact with higher atmospheric humidity, for example if the articles are present in damp rooms, such as bathrooms and also in pools or laundries, in the interior of ships and the like, or if they are exposed to high atmospheric humidity outdoors. Contact with moisture may also be contact with liquid water or with stagnant moisture, for example by the action of rain, contact with river or seawater in the case of hydraulic structures or in ships.

The production of the articles can be effected in manner known per se analogously to the production of articles from wood materials. It comprises typical measures of wood processing, such as sawing, cutting, planing, milling, grinding, drilling, screwing, nailing, adhesive bonding, laminating and the like. As a rule, the modified wood material is used as a starting material in the production of the articles. However, the articles can also be first produced from an unmodified wood material and the wood constituents then subjected to modification as described above.

In a first embodiment of the invention, the modified wood material is used for the production of floor coverings. Frequently, veneered materials are used for this purpose, in which the decorative surface exposed to weathering or mechanical load is formed from a veneered laminated layer modified according to the invention. An example of this is parquet, including strip flooring, solid parquet, mosaic parquet, industrial parquet, ready-to-lay parquet, e.g. 2-layer or 3-layer ready-to-lay parquet, veneered floors and sport floors, e.g. two-dimensionally elastic sport floors and point-elastic sport floors, and sprung parquet floors. Wood materials modified according to the invention are also suitable for the production of strip parquet, terrace coverings and the like. Wood materials according to the invention are also suitable for the production of laminate, the wood material modified according to the invention generally forming the presswood layer of the laminate. A special embodiment of the invention relates to a floor covering material for the outdoor and wet area. Conventional floor covering materials for the outdoor and wet area are typically floorboards, planks or boards which are produced from hardwood but are frequently also provided with a surface structuring. These floor coverings are as a rule very expensive owing to the high price of the hardwoods. The resistance to weathering or moisture is not always satisfactory. The wood materials according to the invention now permit the production of floor coverings having high durability also from economical timbers, such as pine, spruce, beech, poplar and the like. In particular, the wood materials according to the invention permit the production of floor covering materials which have a substrate layer comprising a first wood material according to the invention and a top layer or effective layer joined, in particular glued or adhesively bonded, to the substrate material and comprising a second wood material. The material of the substrate layer is typically a wood material according to the invention, comprising an economical wood variety, in particular an economical solid wood, for example a pinewood treated according to the invention. Preferably, the wood material of the effective layer is likewise a wood material according to the invention, preferably a wood material according to the invention having a decorative appearance, for example beech treated according to the invention. The effective layer can, however, also consist of an untreated hardwood or hardwood treated according to the invention, for example of hardwood of durability classes 1 or 1, such as angelim, bangkirai, bongossi, biling a, cumaru, Douglas fir, eucalyptus, fava, garapa, ipe, iroko, itauba, jatoba, karri, limbali, massaranduba, mukulungu, okan, piquia, robinia, tali, tatajuba, torrado or teak. The effective layer typically has a thickness of at least 1 mm, e.g. from 1 to 10 mm, in particular from 2 to 8 mm. The effective layer may have a profile, for example a groove profile. Of course, the thickness of the substrate layer depends on the desired use and the thickness required for this purpose. It is typically in the range from 5 to 100 mm, in particular in the range from 10 to 50 mm. The floor covering may have the forms of sheets, boards, floorboards, planks or gratings. The floor coverings may have means for joining the individual elements of the floor covering, for example tongue-and-groove joints, click joints and the like. Such floor coverings are typically produced by gluing or adhesively bonding the substrate layer to the effective layer in analogy to known methods for gluing wood layers, for example in analogy to methods for the production of terminated woods or for the production of floor coverings for the interior area which have a substrate layer and an effective layer arranged thereon. In particular, the production can be effected in analogy to the method described in PCT/EP2006/001980, the wood materials treated according to the invention being adhesively bonded or glued to one another in contrast to the method described there.

In a further embodiment of the invention, the modified wood material is used for the production of doors and door frames, for example for interior doors but also for front doors. The modified wood material can be used both for the door leaf itself, for parts of the door leaf, for example in the form of solid wood or wood-base material panels for the interior trim of the door leaf or in the form of veneer for the decorative layer on the door leaf.

In a further embodiment of the invention, the modified wood material is used for the production of windows for example of window frames and/or casements. The window frames and casements can be produced from the same wood, but also from different types of wood. It is likewise possible for the frame to be produced from a material other than wood and for only the casements to be produced from a wood material modified according to the invention. The wood materials modified according to the invention can also be used for the production of window sills.

In a further embodiment of the invention the modified wood material is used for the production of pieces of furniture in particular of those pieces of furniture or furniture parts which are typically produced from wood or wood materials. These include cabinets or parts of cabinets, such as the carcass, the doors or bases, shelves, bed frames, slatted frames, sofa frames, chairs, tables or parts of these pieces of furniture, such as table supports, table tops, worktops, in particular kitchen worktops, bathroom furniture and the like. The wood materials modified according to the invention are suitable in particular for pieces of furniture which are exposed to moisture or weathering to a high degree, for example for the production of kitchen furniture or bathroom furniture or for the production of garden furniture, park benches, stadium seats and the like.

In a further embodiment of the invention, the modified wood material is used for the production of articles for hydraulic engineering, for example for bank defenses, hydraulic structures, such as locks, in particular lock gates, water wheels, platforms, pontoons, catwalks and other constructions in and on water.

In a further embodiment of the invention, the modified wood material is used for the construction of buildings or parts of buildings. These include, in addition to the abovementioned window construction, in particular the use of modified wood materials in the form of structural timbers for the construction of wooden houses, for framework construction, for the construction of roof structures, for buildings constructed by the post and beam method, for the construction of bridges or observation platforms and carports and for building parts, such as terraces, balconies, balcony railings, dormers of roofs and the like. This furthermore includes the use of modified wood materials for the construction of staircases, including steps, for example in the case of wood steps in metal staircase constructions, but also for staircases and railings produced completely from wood materials.

In a further embodiment of the invention the modified wood material is used for facade construction. The modified wood material can form both a component of the facade substructure and the visible part of the facade, for example in the form of facade panels of the modified wood material, facade boards of modified wood, clapboards of modified wood and the like.

In a further embodiment of the invention, the modified wood material is used for the production of wall elements and ceiling elements, for example panels, tongue-and-grooved boards, and cassette ceilings, but also ceiling suspensions, mobile walls or wall elements constructed by the post and beam method, and ceiling and wall claddings. Wood-base materials based on finely divided materials in the form of boards, for example OSB boards, particle boards, OSL boards, PSL boards, insulating boards and medium density (MDF) and high-density (HDF) fiberboard and the like and veneered materials, such as veneered fiberboards, veneered blackboards, veneered particle boards, including veneered OSL and PSL boards, plywood, glued laminated wood, laminated wood and veneered laminated wood (e.g. Karto laminated wood), are particularly suitable for this purpose.

In a further embodiment of the invention the modified wood material is used for garden construction, for example for the production of fences, palisades, screening elements, summerhouses, pergolas, birdhouses and the like.

In a further embodiment of the invention the modified wood material is used for the production of outdoor play equipment, for example for climbing frames, swings, in particular swing frames and swing seats and boards, play landscapes with apparatuses for climbing, swinging and/or sliding, frames of cable railways and the like.

In a further embodiment of the invention, the modified wood material is used for the production of household articles, for example for knife blocks, bread boxes, wooden dishes, bathroom accessories, such as bathtubs, brushes and the like, and furthermore for chopping boards, cooking utensils, such as cooking spoons, spatulas, rolling pins, salad servers, noodle forks and the like.

In a further embodiment of the invention, the modified wood material is used for boat construction, both for the construction of hulls, for example for planking, for frames and keel, for motor mounting, for upright material, such as masts and spars but also for deck superstructures and deck planking, and other exterior apparatuses, such as gratings across openings, cleats, steering wheel, instrument panels and the like, and for the interior trim of ships, for example for built-in cabinet fittings, built-in berth fittings, cabin walls and doors, engine claddings, companion ways, ladders and the like.

In a further embodiment of the invention, the modified wood material is used for sauna construction, for example for walls, doors, benches, oven claddings and the like.

In a further embodiment of the invention the modified wood material is used in vehicle construction, for example for interior trims of the passenger compartment and of the trunk and engine compartment linings, and furthermore insulations, for example of the engine compartment and of the trunk, and furthermore for dashboards, wooden decoration and the like.

In a further embodiment of the invention, the modified wood material is used for the production of toys, such as building blocks, marble runs, toy houses and toy equipment, such as dolls houses, dolls kitchens and the like, toy cars, toy aircraft and toy ships, for model building, such as model cars, model aircraft and model ships, games equipment, such as rackets, racket frames and the like.

In a further embodiment of the invention, the modified wood material is used for the production of musical instruments, in particular for the construction of string instruments, such as guitars, lutes, harps, violins, violas, violoncellos, contrabasses and parts thereof, such as bridges, body, scroll and pegs, and furthermore for the construction of wooden wind instruments, such as clarinets, oboes, bassoons, recorders, etc.

In a further embodiment of the invention, the modified wood material is used for the production of sports equipment, in particular such sports equipment which is typically produced from wood or wood materials, but also for sports equipment in which wood has not been used to date owing to its poor strength and hardness. Sticks, such as hockey sticks and ice hockey sticks, equipment for throwing such as javelins and discus, oars and sculls, for the construction of sports rowing boats, such as sculls, kayaks, single sculls, Canadian canoes, gigs and the like, may be mentioned by way of example.

In a further embodiment of the invention, the modified wood material is used for the production of housings, including housing parts for machines, electrical equipment and the like.

Owing to the increased strength of the modified wood materials according to the invention, a weight saving due to lower material requirement can be achieved in many cases. In addition, the articles are much less susceptible to weathering influences and the influence of moisture. Owing to the high dimensional stability due to the low swelling and shrinkage and the manufacturing tolerances achievable thereby, the modified wood material can also be used for the production of articles for which it has not been possible to date to use wood.

### Impregnation of Wood Materials

### PRODUCTION EXAMPLE 1

DMDHEU modified with diethylene glycol and methanol (mDMDHEU) was diluted to 30% by weight with water and mixed with 1.5% by weight of MgCl₂.6H₂O. Pinewood boards dried to about 12% wood moisture and having the dimensions 150×10×2.5 cm were introduced into an impregnating plant. In the impregnating plant, reduced pressure of 40 mbar (absolute) was applied for 30 minutes. The impregnating plant was then flooded with the impregnating agent. The reduced pressure of 50 mbar absolute was kept constant. A pressure of 10 bar was then applied for 2 hours. The pressure phase was terminated and the residual liquid removed. The wood boards were then stored in a drying chamber controllable via temperature and atmospheric humidity and fixed so that distortion was impossible. The chamber was brought to 120° C. and a relative humidity of about 95%. These moist conditions were maintained until a temperature of at least 120° C. was reached for 48 hours in the interior of the wood bodies.

The subsequent drying of the wood bodies was carried out on a thoroughly ventilated wood stack.

The boards thus obtained can be further processed to give any desired articles, e.g. to give tongue-and-groove floorboards.

### PRODUCTION EXAMPLE 2

The production of impregnated pine boards was effected analogously to production example 1, the following impregnating agent being used instead of the impregnating agent used there: mixture obtainable by diluting a commercially available, aqueous preparation of 1,3-bis(hydroxymethyl)-4,5-dihydroxyimidazolidin-2-one (DMDHEU) with water to a concentration of 30% by weight and dissolving 15 g/kg of MgCl₂.6H₂O in the mixture.

### PRODUCTION EXAMPLE 3

The production of impregnated pine boards was effected analogously to production example 1, the following impregnating agent being used instead of the impregnating agent used there: mixing of 2.5 kg of a commercially available, aqueous preparation of 1,3-bis(hydroxymethyl)-4,5-dihydroxyimidazolidin-2-one (75% strength by weight) with 2 kg of a commercially available, 70% strength by weight, aqueous solution of a reaction product of melamine with formaldehyde and methanol (molar ratio 1:4:4) and 200 g of MgCl₂.6H₂O and dilution of the resulting mixture with 5.2 kg of water.

### PRODUCTION EXAMPLE 4

Beech strips and beech boards were treated in a manner analogous to production example 1.

The beech timbers thus obtained were further processed to give pieces of garden furniture, namely to give garden tables, garden chairs and garden benches, which in each case had a multiplicity of pegged joints and/or intermeshing joints.

The pieces of garden furniture showed neither significant visual changes nor damage to the joints of the timbers even after weathering for several months in the open air.

### PRODUCTION EXAMPLE 5

Pine beams and pine boards were treated in a manner analogous to production example 1.

The pine timbers thus obtained were further processed to give Euro pallets. The Euro pallets showed no significant visual changes even after weathering for several months in the open air.

### PRODUCTION EXAMPLE 6

Pine beams and ripple floorboards comprising pine wood (pine boards, one surface of which was provided with longitudinal rippling) were treated in a manner analogous to production example 1.

The pine beams thus obtained were screwed to the ripple floorboards to give a terrace covering. The terrace covering showed no significant visual changes even after weathering for several months in the open air.

1: The method of using modified wood materials (wood-base materials) which comprise at least one crosslinkable nitrogen compound in a crosslinked form distributed in the wood, for the production of articles which comprise at least one wood material.

2: The method according to claim 1, the modified wood material (wood-base material) comprising the nitrogen compound in an amount of at least 1% by weight, calculated as nitrogen and based on the weight of the modified wood material (wood-base material).

3: The method according to claim 1, wherein the crosslinkable nitrogen compound is selected from:
1,3-bis(hydroxymethyl)-4,5-dihydroxyimidazolidin-2-one,
1,3-bis(hydroxymethyl)-4,5-dihydroxyimidazolidinone, which is modified with a C₁-C₆-alkanol, a C₂-C₆-polyol or an oligoalkylene glycol,
1,3-bis(hydroxymethyl)urea,
1,3-bis(methoxymethyl)urea;
1-hydroxymethyl-3-methylurea,
1,3-bis(hydroxymethyl)imidazolidin-2-one (dimethylolethyleneurea),
1,3-bis(hydroxymethyl)-1,3-hexahydropyrimidin-2-one (dimethylolpropyleneurea),
1,3-bis(methoxymethyl)-4,5-dihydroxyimidazolidin-2-one (DMeDHEU),
tetra(hydroxymethyl)acetylenediurea,
low molecular weight melamine-formaldehyde resins and
low molecular weight melamine-formaldehyde resins which are modified with a C₁-C₆-alkanol, a C₂-C₆-polyol or an oligoalkylene glycol (modified MF resins).

4: The method according to claim 1, wherein the modified wood material (wood-base material) is a modified solid wood.

5: The method according to claim 1, wherein the modified wood material (wood-base material) is a modified wood-base material.

6: The method according to claim 1, wherein the article comprising a plurality of parts connected to one another, at least one part being produced from a modified wood material (wood-base material).

7: The method according to claim 6, wherein at least two parts of the article being connected to one another by a friction joint, at least one part of the parts connected to one another by a friction joint is produced from a modified wood material (wood-base material).

8: The method according to claim 1, wherein the wood constituent of the modified wood material (wood-base material) is a wood which is assigned to impregnatability class 1 or 2 according to DIN EN 350-2.

9: The method according to claim 1 for the production of articles which are exposed to moisture or weathering conditions.

10: The method according to claim 1 for the production of floor coverings.

11. The method according to claim 1 for the production of doors and door frames.

12: The method according to claim 1 for the production of windows.

13: The method according to claim 1 for the production of pieces of furniture.

14: The method according to claim 1 for the production of articles for hydraulic engineering.

15: The method according to claim 1 for the construction of buildings or parts of buildings.

16: The method according to claim 15, wherein the modified wood material is structural timber.

17: The method according to claim 15 for the construction of staircases and railings.

18: The method according to claim 15 for facade construction.

19: The method according to claim 1 for the production of wall elements and ceiling elements.

20: The method according to claim 1 for garden construction.

21: The method according to claim 1 for the production of outdoor play equipment.

22: The method according to claim 1 for the production of household articles.

23: The method according to claim 1 for boat construction.

24: The method according to claim 1 for sauna construction.

25: The method according to claim 1 in vehicle construction.

26: The method according to claim 1 for the production of toys.

27: The method according to claim 1 for the production of musical instruments.

28: The method according to claim 1 for the production of sports equipment.

29: The method according to claim 1 for the production of housings.
